(19) United States
(12) Patent Application Publication
(10) Pub. No.: US 2008/0289399 A1
(43) Pub. Date: Nov. 27, 2008

(54) FLUID QUALITY SENSOR

(75) Inventors: Johnny G. Cooper, Grand Blanc, MI (US); John Sonnenberg, Grand Blanc, MI (US); Ron Parrott, Troy, MI (US); Mark Baybutt, Webster, NY (US); Nicholos Mackos, Rochester, NY (US); Mark Redding, Rush, NY (US)

Correspondence Address: BASCH & NICKERSON LLP, 1777 PENFIELD ROAD, PENFIELD, NY, 14526, US

(73) Assignee: Flowtonics, LLC, Rochester, NY (US)

(21) Appl. No.: 12/116,448

(22) Filed: May 7, 2008

Related U.S. Application Data
(60) Provisional application No. 60/917,426, filed on May 11, 2007.

(51) Int. Cl. G01N 11/00

(52) U.S. Cl. 73/53.01

(57) ABSTRACT

Disclosed are systems and methods for measuring the fluid quality of oil, or other fluids used in or with equipment, machinery and the like. The system may be integrated with a filter device and used, for example, to characterize such fluids and to permit a determination of when to make oil or other fluid changes due to a change in the quality of the oil or fluid.

This application claims priority from U.S. Provisional Patent Application No. 60/917,426 for a FLUID QUALITY SENSOR, filed May 11, 2007 by Johnny G. Cooper et al., which is hereby incorporated by reference in its entirety.

U.S. Pat. No. 7,239,155 to C. Byington et al., for an ELECTROCHEMICAL IMPEDANCE MEASUREMENT SYSTEM AND METHOD FOR USE THEREOF, issued Jul. 3, 2007, and related U.S. application Ser. No. 10/987,069 filed Nov. 12, 2004 (published as 2005/0104607 A1), are also hereby incorporated by reference in their entirety.

This disclosure relates generally to a sensing system suitable for measuring the fluid quality of oil, or other fluids used in or with equipment, machinery and the like. This sensing system could be integrated with a filter device and used, for example, to characterize such fluids and to permit a determination of when to make oil or other fluid changes due to a change in the quality of the oil or fluid.

### BACKGROUND AND SUMMARY

In many cases the failure mechanism for a mechanical system can be traced back to fluid quality degradation or contamination of the system. It is precisely for this reason that in-situ oil quality analysis is often considered an enabling aspect of effective diagnostics and prognostics for mechanical systems. The present disclosure directly addresses this need by adapting a sensor system for use in various embodiments. Such embodiments facilitate the determination of the fluid's characteristics, for example, a fluid's broadband electrical impedance, which may then be used to predict fluid quality and degradation in a range of fluid systems.

Considering the management of vehicle fleets, for example, proper maintenance has always involved utilizing maintenance schedules for fluid changes such as oil, transmission fluid, and the like. In conventional fleet management systems, such fluids are changed on a periodic basis (time/mileage) to avoid chemical breakdown and/or contamination. Alternatively, some fleet management systems employ tests to regularly examine the fluid quality. Such testing is, however, a lengthy and expensive way to determine the quality of the fluid prior to requiring a change out.

Moreover, in diesel truck applications oil changes have traditionally been done based upon the number of miles that the truck has traveled, not withstanding the fact that the oil may still be very clean. In conventional engines (gas or diesel) major contaminants such as soot, fuel and water degrade lubricating fluids such as motor oils and transmission fluid, and can rapidly accumulate to the point where the contaminants can cause damage to an engine. To minimize the likelihood of damage, fleet management maintenance schedules typically err on the side of safety and change out lubricants more frequently than is required—often resulting in changing lubricants that remain perfectly suitable for use.

More innovative fleet management systems may utilize fluid analyses to determine the quality of their oil or lubricating fluids and thereby reduce the number of oil or fluid changes that are carried out. For example, oil may be sampled for an external analysis to determine the degree of degradation that has occurred. Sometimes, the relative levels of contaminants detected in such analyses may point to a specific engine problem, where a situation has arisen that causes rapid degradation of the fluid prior to its replacement. For example, the presence of high soot may arise from a piston ring problem, or high coolant levels may be caused by a leak in the engine block. If such contaminants were not noticed or detected, the engine could sustain serious damage. In some situations the possible damage is often used to justify expensive, sampling and analysis of lubricants.

Alternatively, when fluid characterization and associated diagnostics are able to be performed in-situ and in real-time, the benefits will be two-fold. First, it is possible to eliminate the need for the expensive sampling/analysis. Second, the real-time characterization of fluids will permit the use of such fluids until they need to be replaced, thereby extending oil change intervals, which save on labor, fluids, parts (e.g., filters) and fluid disposal. Furthermore, in-situ and real-time fluid characterization may further reduce maintenance costs by optimizing the timing of maintenance and/or reducing the requirement for vehicle redundancy due to maintenance.

One aspect of the disclosed embodiments includes technology for measuring and characterizing changes in electrochemical properties of the various fluids, particularly including motor oil and other lubricants. One example of a sensing system is that described in U.S. Pat. No. 7,239,155 to C. Byington et al., assigned to Impact Technologies, LLC, previously incorporated by reference. Such a technology combines various oil contamination and fluid quality estimations that are determined through a combination of advanced analyses and classification processes built into or operating on data obtained from, a fluid quality sensor disclosed in the various embodiments herein.

In other words, fluid quality measurement systems disclosed herein would be an advantage to both vehicle operators as well as the vehicle fleet management industry. When the in-situ sensor provides diagnostic and prognostic information on the quality and condition of various fluids utilized in the operation of fleet vehicles, the cost of fleet management operations can be optimized.

Disclosed in embodiments herein is a filter integrated fluid quality measurement system, comprising: a filter associated with a fluid path; a sensor including a plurality of electrodes, said electrodes being generally aligned and operatively associated with said filter, and at least one end of a first and a second electrode extending into the fluid path to enable automatic fluid sampling in the fluid path; and a data transmission channel (wired, wireless, etc.) in communication between said sensor and a data collection device, for receiving data from the sensor. Further disclosed in embodiments herein is an engine fluid quality measurement system, comprising: a device operatively associated with a fluid path in the engine; a multi-electrode sensor, at least two of said electrodes being generally aligned with one another and operatively associated with said device, and at least one end of said two electrodes extending into the fluid path to enable fluid sampling in the fluid path; and a data transmission channel in communication between said sensor and a data collection device, for receiving data from the sensor.

### BRIEF DESCRIPTION OF THE DRAWINGS

FIG. 1 is a schematic block diagram illustrating an embodiment of the disclosed filter integrated fluid quality measurement system;

FIG. 2 illustrates a perspective view of an embodiment of a filter integrated fluid quality sensor installed on an engine;

FIG. 3 is an alternative view of an embodiment of a filter integrated fluid quality sensor;

FIG. 4 is an alternative view of an and integrated standoff embodiment similar to that depicted in FIG. 4;

FIG. 5 and FIG. 6 are views of a filter stand-off for a screw-on fluid quality sensor embodiment;

FIG. 7 is a perspective view of an alternative embodiment of a filter integrated fluid quality measurement system attached to an engine;

FIG. 8 is an exploded, cut-away view of a conventional oil filter having a fluid quality sensor integrated therewith in accordance with a disclosed embodiment similar to that depicted in FIG. 7;

FIG. 9 is an exemplary illustration of an alternative sensor configuration;

FIGS. 10-12 are illustrative examples of a filter embodiment from various perspectives to illustrate details of the embodiment; and

FIG. 13 is a perspective view of an alternative sensor embodiment suitable for integration with a fluid bypass manifold.

The various embodiments described herein are not intended to limit the invention to those embodiments described. On the contrary, the intent is to cover all alternatives, modifications, and equivalents as may be included within the spirit and scope of the appended claims.

### DETAILED DESCRIPTION

As more particularly set forth below, the disclosed system and methods are directed to a fluid quality sensor that monitors, analyzes and reports the quality of fluids (e.g., engine oil) used in vehicles, watercraft, aircraft, or other equipment and machinery. In one embodiment, the fluid quality sensor is used to both generate an alternating current (AC) broadband signal that is input to the fluid, interrogates the fluid resulting in signal changes as it passes through the fluid. Various electrochemical characteristics of the fluid (e.g., resistance, conductance, capacitance, dielectric constant, inductance, and derived combinations thereof) affect the measured response of the signal passing through the fluid. The measured signal response is analyzed with relation to the interrogation signal to characterize the fluid and its current properties. Not only is the system able to conduct the interrogation of the fluid in-situ, but it is also able to analyze and complete a characterization in real time. In one embodiment, the fluid quality sensor may examine and analyze the levels of water, soot, fuel and/or acid contamination, as well as other characteristics of the fluid. As a result, the fluid quality may be monitored in a real time, in-situ fashion without taking an oil sample and waiting for laboratory results.

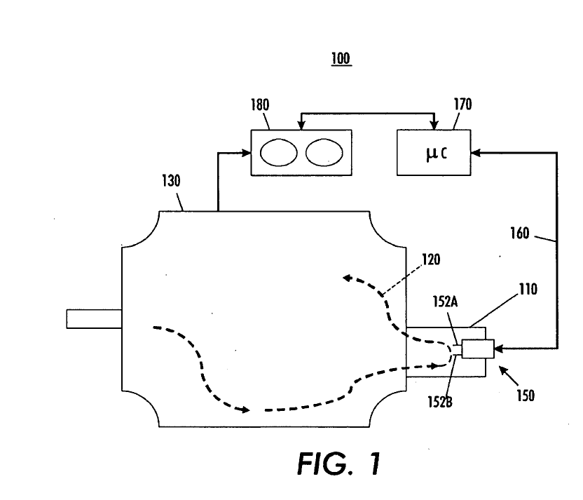

Referring to FIG. 1, depicted therein is a schematic block diagram illustrating an embodiment of the disclosed filter integrated fluid quality measurement system 100. System 100 includes, a filter or similar device 110 associated with a fluid path 120 in a piece of equipment 130 (e.g., engine, transmission, axle, etc.). Device 110 comprises a sensor 150 including a plurality of electrodes 152A, B, etc. Electrodes 152A, B are generally aligned (e.g., alignment may include relationships such as parallel, co-axial, congruent or otherwise extending in a similar or common direction yet separated from one another), and are operatively associated with the filter or device 110 so as to assure that at least one end of electrode 152A and electrode 152B extend into the fluid path 120 to enable automatic sampling of the fluid moving along the fluid path. The system also includes a data transmission channel (wired, wireless, etc.) 160 for communication between the sensor 150 and a data collection device (e.g., microcontroller) 170, for receiving data from the sensor. Microcontroller 170 processes the signals from sensor 150 and provides output that may be passed to a controller and/or display system associated with the equipment (e.g., vehicle dashboard light display 180 (e.g., backlight, LED, LCD, etc.)). It will be appreciated that various wireless communication techniques may be applicable, including infrared, Bluetooth™, sonic/ultrasonic, radio frequency, etc. Some of these wireless communication technologies may be more preferable than others in electrically “noisy” environments such as engine compartments and the like. It should be further understood that commonly available receivers, transmitters and/or transceivers may serve the purpose of the wireless communication channel.

When a fluid degrades, for example engine oil, the characteristics change. The changed characteristics may include, but are not limited to, breakdown of base oil composition, breakdown of additive packages (chemicals added to or supplementing the base oil), and the presence of foreign contaminants. Such changes may be detected by changes in direct measurement or variations in sensed electrochemical impedance of the fluid. The fluid quality sensor 150, either independently or in conjunction with a processor or microcontroller 170, may extract and analyze the information received to identify changes in the characteristics.

In one embodiment, such characteristics may be monitored using an impedance module. Although generally illustrated in various embodiments in association with an engine, the fluid quality measurement system has a wide application including transmissions, and drive system components (e.g., axles), hydraulic systems, refrigeration equipment, industrial machinery, food processing, chemical systems, crude oil production, etc. Applications for such systems include various vehicles, boats and other marine vessels, rail cars, locomotives and other mass transit systems, power generation systems (e.g., gas, fuel, steam, wind turbines), compressors, refrigeration and chillers, industrial machinery, crude oil production equipment, and food processing.

As noted herein, the disclosed fluid quality measurement system has applicability to engine oil and similar lubricants. It should also be appreciated that other fluids, both in engines and in other devices may exhibit similar characteristic changes (e.g., breakdown) after prolonged use or contamination and would be suitable for monitoring in accordance with the disclosed system. It is also known that such fluids may pass through fluid paths in the associated devices; fluid paths that may also include filters. Additional fluids where the disclosed fluid quality measurement system may be applicable include, but are not limited to, fuels, urea, transmission fluids, and lubricants (e.g., axel and bearing lubricants).

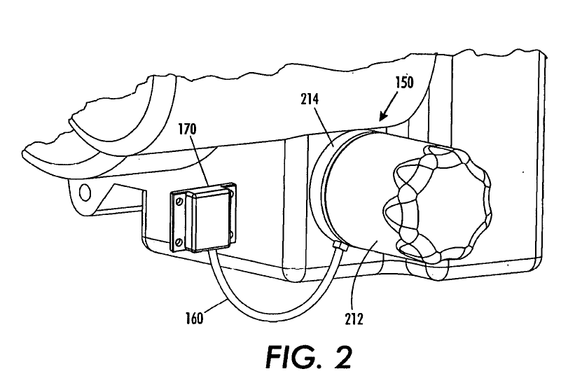

Referring next to FIG. 2, depicted therein is a view of a filter integrated fluid quality sensor, 150, which includes an oil filter 212 and a fluid quality sensor standoff 214 integrated with the oil filter. An information module or similar data collection device 170, as noted above, is installed in a suitable location in the vehicle to collect and analyze information. Between the fluid quality sensor 150 and module 170, an electrical harness 160 connects the components in a wired configuration. In one embodiment, although other sensing techniques may be suitable for the disclosed embodiment(s), the fluid quality sensor 150 injects broadband AC interrogation signals into to the oil flowing through oil filter 212 via an electrode and another sensor electrode receives the associated response signal. Sensor 150 passes the response signal through the communication channel 160 (e.g. electrical harness), and the signal is sent to module 170 where further analysis is conducted to characterize the fluid based upon the response signal. It will be appreciated that further control and processing operations may be carried out via programmatic controls initiated by module 170. Such controls may be pre-programmed and they may be periodically or dynamically initiated in response to the fluid characteristics or other operating parameters associated with the engine (e.g., sampling continuously, sampling every five minutes, sampling every 2,000 miles, etc.). A display device (e.g., a liquid crystal display, a light emitting diode, etc.) may be adapted to display meaningful information in relation to the fluid characteristics to a user. As noted above, such information might be provided to a dashboard display as a warning light—signaling that it is time to change the oil. Alternatively, the display may include additional information that provides a characteristic of the fluid (oil), such as viscosity, contaminant level, etc. that could be depicted on a gauge or similar user-viewable display.

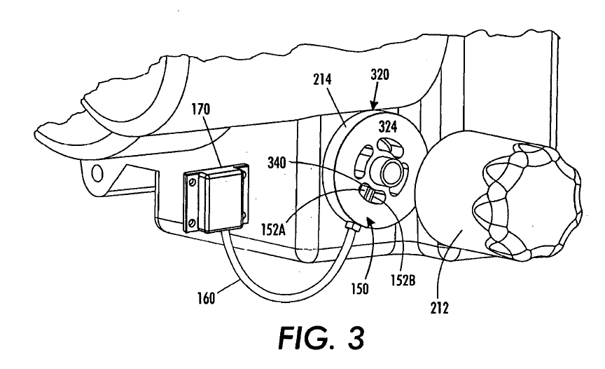

FIG. 3 is a similar embodiment to that depicted in FIG. 2, but shows separated components of a filter integrated fluid quality sensor. The sensor 150 is molded into the filter with a mechanical connection 160 to module 170. The filter integrated sensor may be used with various conventional engines without modifications as the sensor is integrated with the filter 212 directly or as part of a standoff 324 that simply provides an interface through which the oil flows in a fluid path between the engine and the filter. Such an embodiment not only permits the use of conventional oil filters, but also permits the easy upgrade or replacement of the sensor. The filter integrated sensor depicted in FIG. 3 also provides an added advantage because it may reduce negative downstream effects. Such effects could include, for example, reducing or eliminating any build-up of contaminants on the sensor electrodes—either through change-out of the sensor with the filter in which it is integrated, or by placing the sensor downstream of the filter so that contaminants/particulates are filtered out and are less likely to come into contact with the electrodes. Although placement of the sensor in a post-filter or downstream location may provide advantages to filter life and provides an indication of the characteristics of the fluid be re-circulated in the device, the embodiments disclosed herein also contemplate placement prior to the filter in order to characterize the fluid in a pre-filtration condition.

The filter integrated sensor of this embodiment may be constructed of various materials, including metals, plastics or other polymer compositions. It will be appreciated that in a plastic configuration the sensor components may be molded or formed in association with the standoff 324 (or mounting plate of the filter itself), thereby reducing the cost of a filter with an integrated sensor. Moreover, the configuration depicted in FIG. 3 is advantageous because it is easy to grip, thereby making it easy to install and remove. The outer surface of the standoff 324 may be provided with various surface features that improve the ease of gripping/installing the standoff as compared to metal-cased filters that are slippery when exposed to oil. For example, the standoff may be designed with a textured surface and/or raised ribs for extra leverage when tightening or loosening by hand.

In a further alternative embodiment to FIG. 3, the filter integrated sensor may include a socket hole that only works in one direction, so any problem of over-tightness may be reduced, or eliminated. In addition, the socket hole may be molded into the top or bottom of the filter, so that removal of the filter integrated sensor from the engine can be easily accomplished. As noted above, the filter housing or canister, possibly being formed from a plastic or metal material, or combination thereof, may further include a molded-in or stamped-in feature that makes it easier to install the filter. Such a feature may be a recessed region having the shape of a standard-size ratchet drive (e.g., 0.5″ ratchet) so that it may be tightened and/or loosened using a ratchet, torque wrench, etc. Alternatively, the canister may include a hex-shaped portion that extends from the end of the canister to permit a common ratchet to engage the canister for tightening or loosening the canister. Furthermore, the filter housing (canister), mounting plate and associated manifold threads may be made of plastic, which would not damage the metal threads on the engine's filter spud. The plastic filter can thereby further protect the engine by not only filtering the oil, but also by eliminating the danger of metal shards or shavings coming from the metal casing. One or more plastic filter components, combined with an integrated sensor, offers several improvements for both oil filtration and oil quality measurement.

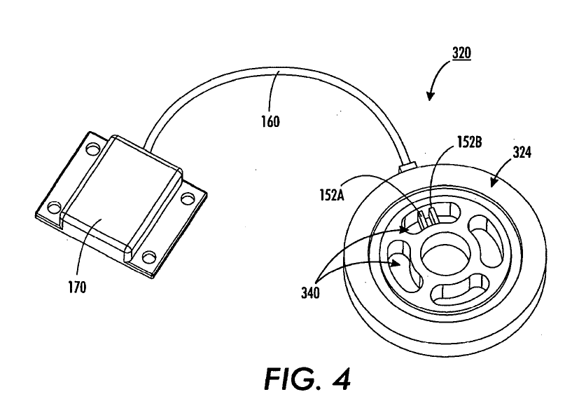

As described above, FIGS. 2 through 4 illustrate a stand-off fluid sensor embodiment generally indicated by reference numeral 320. The standoff is integrated with a spin-on type oil filter 212. Stand-off fluid sensor 320 includes a sensor and standoff body 324 and sensor electrodes 152A, B that extend into a fluid path (orifice 340) through which oil flows for filtering. The standoff body 324 may be formed in any suitable size and shape as long as it may be spun on to the corresponding oil filter and engine filter spud. For example, the sensor body 324 shown in FIG. 2 and FIG. 3 as disk-like in shape. Several orifices 340 are located in the body allowing oil to pass or flow there through. Sensor electrodes 152A, B, which include an anode, a cathode, and possibly a reference electrode(s), are installed within one of the orifices so as to be in contact with oil passing through the spin-on oil filter 212, 320. Similar to the system of FIG. 1, an electrical harness 160 and a processing module 170 are included in this embodiment.

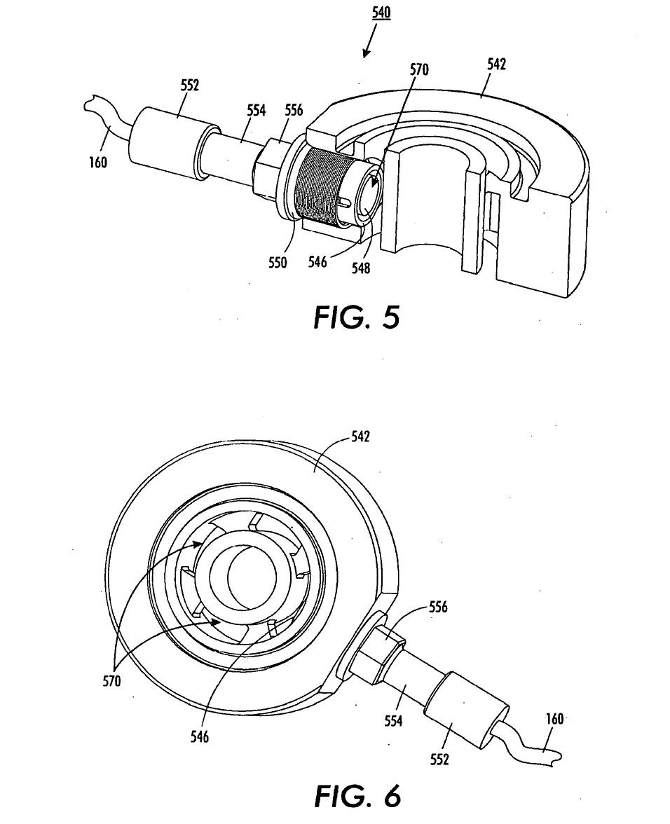

FIG. 5 and FIG. 6 are views of a filter stand-off and a screw-on fluid quality sensor, generally indicated by the numeral 540, that allows for the filter integrated fluid quality sensor to be added to a vehicle, without the requirement for any re-tooling of the engine block or any other such modifications, and will work with convention oil filters. The sensor of the present embodiment can be screwed on adjacent to a traditional oil filter (not shown), which is designed to be removable and replaceable when an oil change is performed. In such an embodiment, sensor assembly 540 is merely screwed into place prior to the oil filter being put in, allowing the generally parallel fluid quality electrodes 546 and 548 to come into contact with oil as it flows by through the standoff between the engine and the attached filter.

In practice, the stand-off embodiment illustrated in FIGS. 5 and 6 may install into or with the filter (not shown) by any suitable fasteners, including a mirror-image of the engine spud. Sensor 540 generally includes electrodes 546 and 548 associated therewith. Electrode 546 has a dielectric-staging compound insulating it from and preventing contact with any surrounding conductive materials. In one embodiment electrode 548 encloses electrode 546. Electrode 548 may be threaded for screwing in to standoff 542. As shown in FIG. 5, the distal ends of electrodes 546 and 548 face toward and are exposed within an orifice 570 through which oil flows. The proximal ends attach to a sensor electrode housing 554 that is fastened by a hexagon nut 556 to the standoff body. An “O” ring oil seal 550 may be used at the proximal ends of the electrodes 546 and 548 to secure the sensor installation and to prevent any oil or fluid from leaking. An electrical harness 160, possibly including a strain relief member, is attached to the sensor electrode housing 554 for transferring information.

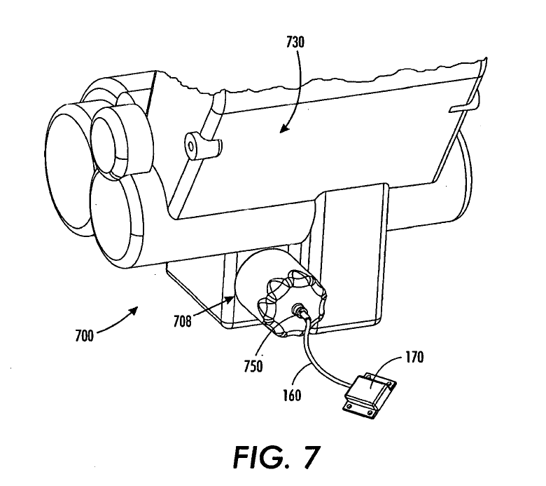

Referring next to FIG. 7, depicted therein is an alternative embodiment of a filter integrated fluid quality measurement system 710. System 710 includes a sensor 750 molded into the filter. More particularly the filter canister 720 includes a disconnectable communication channel (e.g., wire harness 160) for communication to the processor module 170. The filter integrated sensor may be installed in conventional engines without modifications. In another alternative, a wireless version system 710 may include not only a wireless transceiver as communication channel 160, but also an associated, or self-contained, power supply to operate not only the sensor itself but the wireless communications link with module 170. As suggested previously, the filter integrated sensor of this embodiment may be made of metal or plastic, and may be further enhanced so as to be easy to grip, and thereby easy to install and remove.

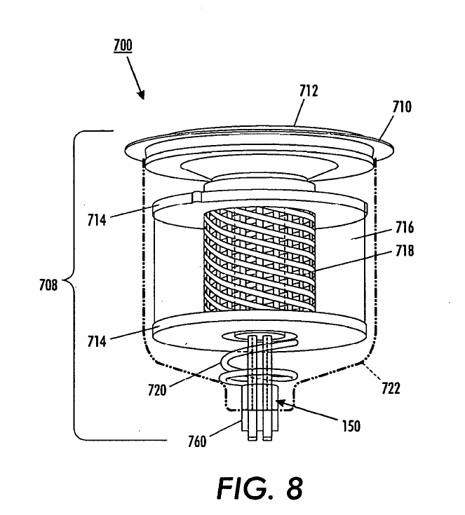

Returning to FIG. 7, in conjunction with FIG. 8 the embodiment illustrated contemplates the inclusion of the sensor and associated electrodes into a region in the filter canister. The following discussion of the filter integrated fluid quality measurement system 700 is done with regard to a conventional oil filter for purposes of explanation only, and this disclosure is not limited to such fluids or filter configurations. As illustrated a mounting plate 710 provides a sealing surface for gasket 712 so that the filter 708 may be sealed to an engine 730. The plate further provides for threaded attachment to the engine via a conventional spud (not shown). End caps 714 retain the filter media and provide an outlet for clean oil. Although the designs of such filters vary, they often include a pleated filter media 716 about a spiral-wound center tube 718 that provides internal support. A coiled spring 720 abutting against the canister 722 ensures a constant load on the inner element to maintain the seal between the upper cap, the inner element support, and the mounting plate even during a pressure surge.

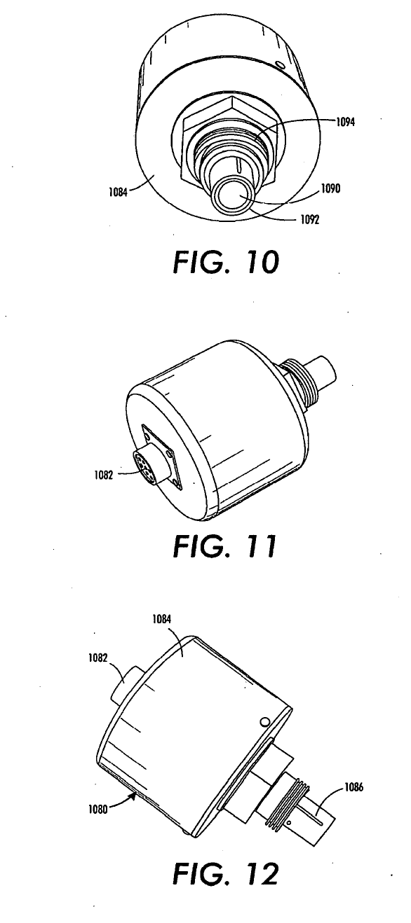

As noted previously, the filter canister 722 encloses the assembly, and may provide “flutes” (FIG. 7) or other features at the closed end for ease of removal by hand or with an oil filter wrench. It is in the canister that the fluid quality sensor 150 is added, whereby the parallel (e.g., co-axially aligned) sensor electrodes extend into and through the coiled spring, thereby placing exposed sensor electrodes into the inner region of the oil filter in direct contact with oil flowing therethrough. As previously discussed, the sensor may include a plug-type or similar removable connection 760 (e.g., multi-pin (FIGS. 10-12), multi-blade, etc.) to establish the communication channel, via a mating connector, with the processing module 170. Sensor 150 is electrically isolated from the oil filter canister, and the electrodes themselves are also electrically isolated from one another so that the interrogation signal injected into the oil or fluid by one electrode can be received by the other electrode and then suitably stored and/or processed. It will be appreciated that certain signal conditioning may occur at the sensor in each of the disclosed embodiments, whereby a conditioned signal (or perhaps even a stored signal) is transmitted to processing module 170 as opposed to raw sensor data. It may also be the case that all processing is accomplished on circuitry directly associated with the sensor itself so as to avoid the need for processing module 170—or to at least substantially reduce the processing requirements thereof. In such embodiment, sensor 150 would further include electronic components capable of performing the required operations.

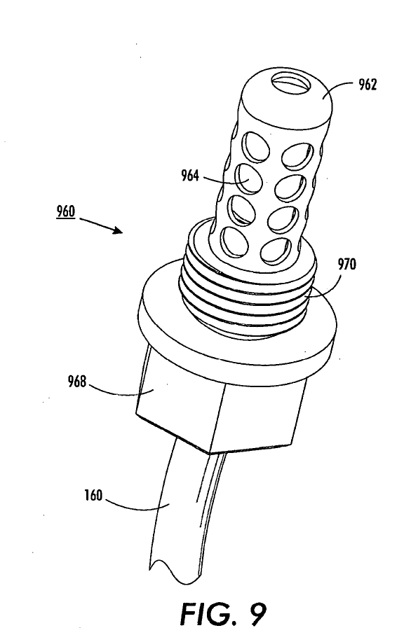

Turning next to FIG. 9 there is depicted an alternative embodiment for the fluid quality sensor, generally indicated by reference numeral 960, adapted to be incorporated into a threaded orifice. Such an embodiment may be used as the sensor in the system of FIGS. 7-8, or may be easily incorporated into the oil drain plug of an engine without requiring any re-tooling of the block. Sensor 960 includes a pair of generally co-axial sensor electrodes 962 and 964. At the proximal ends of the electrodes 962 and 964 are threads 970 for assembling the sensor into contact with a fluid path.

A hexagonal head 968 is further included as a means for providing a torque so as to seal or seat the sensor assembly to the particular equipment or filter housing. Electrical harness 160 is also included to transfer signals and other electrical information between the sensor and a control module as described previously.

Considering FIGS. 10, 11 and 12, depicted therein are various directional views of yet another embodiment of a fluid quality sensor, generally indicated by the numeral 1080, suitable for use in various embossments as suggested herein. The sensor 1080 includes multi-pin connector 1082, a control electronics enclosure 1084, and electrodes 1090 and 1092. The control electronics enclosure 1084, as noted as an alternative above, may include a processor and algorithms that may control the interrogation and acquisition process as well as interpret the measurements to determine the impedance of the fluid, which can further provide the information regarding fluid character and quality.

The control electronics enclosure 1084 generates and injects broadband AC signal to the oil through electrodes 1086 and receives an associated response signal from the oil for subsequent analysis. The control electronics enclosure 1084 may be constructed out of conductive metal or lined with metal shielding to prevent measurement errors caused by an electrically “noisy” environment in which the sensor may be used. Electrode 1090 represents anode and electrode 1092 represents cathode. Enclosure nipple 1094 includes threads that match the threads on a fluid filter, or a corresponding container or reservoir, ensuring a fluid-tight seal.

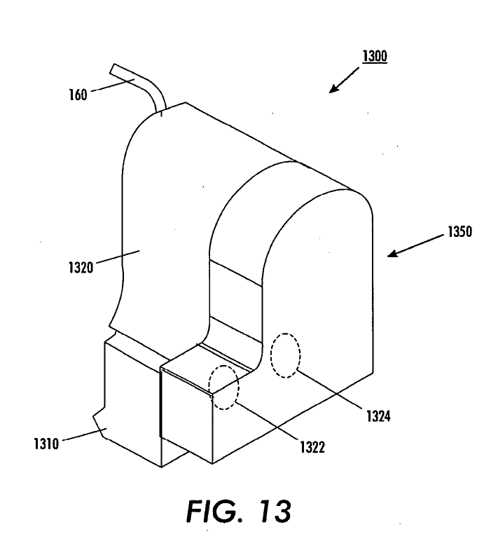

In yet another embodiment of the fluid quality sensor, as depicted in FIG. 13 and generally indicated by the numeral 1300, the sensor may be operatively associated or integrated with a multi-filter bypass manifold. Such a manifold is known, for example the AMSOIL Dual Remote Filtration System models BMK13, BMK15, BMK16, BMK17 and BMK18, may provide a suitable bypass manifold so that the sensor may be integrated with a plurality of filters. The sensor 1350 may be attached to manifold 1310 (shown as a partial view). The sensor 1350 includes a control electronics enclosure 1320, two ports (inlet 1322/outlet 1324) on the reverse side (shown in dashed lines) of the interface head 1330 to which the control electronics enclosure 1320 is attached or integrated, and a set of electrodes (not shown) that extend into the fluid path that is facilitated by the manifold connections or ports. Although depicted in a configuration suitable for interfacing with an AMSOIL™ manifold, it will be appreciated that sensor 1300 may be adapted for use with any of a number of after-market or equivalent bypass manifolds. Such devices may further include one or more filters or other devices, which are similarly integrated in the assembly that is attached to the engine or device (not shown).

It will be appreciated that various of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A filter integrated fluid quality measurement system, comprising:
a filter associated with a fluid path;
a sensor including a plurality of electrodes, said electrodes being generally aligned yet separated from one another and operatively associated with said filter, and at least one end of a first and a second electrode extending into the fluid path to enable automatic fluid sampling in the fluid path; and
a data transmission channel (wired, wireless, etc.) in communication between said sensor and a data collection device, for receiving data from the sensor.

2. The system of claim 1, wherein said measurement system is vehicle mounted.

3. The system of claim 1, wherein said filter includes a filter stand-off and where said sensor is associated with the stand-off.

4. The system of claim 3, wherein said sensor is a screw-on sensor associated with a fluid path in a bypass filtration mounting plate

5. The system of claim 3, wherein said sensor is a screw-on sensor associated with fluid path in a bypass filtration manifold.

6. The system of claim 3, wherein said sensor is a screw-on sensor associated with the stand-off.

7. The system of claim 1, wherein said fluid path is in an engine.

8. The system of claim 1, wherein said fluid path is in a transmission.

9. The system of claim 1, wherein said fluid path is operatively associated with a hydraulic system.

10. The system of claim 1, wherein said fluid path is operatively associated with a refrigeration system.

11. The system of claim 1, wherein said fluid path is operatively associated with a pneumatic system.

12. The system of claim 1, wherein said fluid path is associated with a processing system.

13. The system of claim 1, wherein said plural-electrode sensor is suitable for monitoring at least one characteristic of a fluid selected from the group consisting of:
engine oil;
coolant;
lubricants;
urea; and
transmission fluid.

14. The system of claim 1, wherein said data transmission channel is provided via a wiring harness.

15. The system of claim 14 further comprising:
an information module, where fluid analysis is conducted; and
a display, adapted to display meaningful information from the information module to a user.

16. The system of claim 3, wherein said stand-off is integrated with a spin-on oil filter.

17. The system of claim 16, wherein said sensor includes, a sensor body and sensor electrodes and where a plurality of orifices are located on the sensor body to thereby allowing a fluid to pass therethrough.

18. The system of claim 1, wherein said fluid path is associated with an axle.

19. The system of claim 1, wherein said electrodes are parallel with one another.

20. The system of claim 1, wherein said electrodes are co-axial with one another.

21. The system of claim 1, wherein said electrodes extend from a sensor electrode housing.

22. An engine fluid quality measurement system, comprising:
a device operatively associated with a fluid path in the engine;
a multi-electrode sensor, at least two of said electrodes being generally aligned with one another and operatively associated with said device, and at least one end of said two electrodes extending into the fluid path to enable fluid sampling in the fluid path; and
a data transmission channel in communication between said sensor and a data collection device, for receiving data from the sensor.

23. The engine fluid quality measurement system according to claim 22, wherein said data transmission channel is a wired communication channel.

24. The engine fluid quality measurement system according to claim 22, wherein said data transmission channel is a wireless communication channel

25. The engine fluid quality measurement system according to claim 22, wherein a data collection device is connected to said sensor.

26. A fluid quality measurement system, comprising:
a bypass manifold operatively associated with a fluid path;
a multi-electrode sensor, of said electrodes being generally aligned with one another and having at least one end thereof extending into the fluid path to enable sensing of a fluid in the fluid path; and
a data transmission channel in communication between said sensor and a data collection device, for receiving data from the sensor.
